(19) United States
(12) Patent Application Publication
(10) Pub. No.: US 2007/0030348 A1
(43) Pub. Date: Feb. 8, 2007

(54) Wireless communication device with range finding functions

(75) Inventor: Thomas David Snyder, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/196,940

(22) Filed: Aug. 4, 2005

(51) Int. Cl. H04N 7/18

(52) U.S. Cl. 348/135

(57) ABSTRACT

A wireless communication device includes a range finder, and is configured to obtain distance measurements via the range finder for processing by the device. Such processing may comprise, by way of example, storing distance measurement information, outputting distance measurement information on a display screen of the wireless communication device, transmitting distance information to a wireless communication network, or outputting tones, pulses, or vibrations as a function of the distance measurement information. The wireless communication device may include a camera, and the range finder may be aligned with the camera, such that related distance information may be obtained for objects imaged by the camera.

### BACKGROUND

The present invention generally relates to wireless communication devices, such as cellular radiotelephones, and particularly relates to incorporating range-finding functions into such devices.

Wireless communication devices historically provided only basic communication functions. Sometimes even the basic functions were quite limited. Limited battery performance and the lack of inexpensive user interface elements (graphical displays, decent audio components, etc.), represent some of the reasons underlying the paucity of extra features in older wireless communication devices. Further, before modern advances in device miniaturization, it simply was not practical to add more than the baseline set of communication features to devices that already were larger than desired.

Network capabilities also played into the mix of feature inclusion considerations. Early wireless communication networks offered traditional circuit-switched voice and fax services, and little else. In that sense, then, it may have made little sense to imbue wireless communication devices with additional features related to non-voice data, because there was no convenient way to transfer such data from them.

All or most of the above restrictions are fading as a consequence of improving battery technologies, relentless device miniaturization, and evolving data networks. These kinds of advances expand the convenience and reach of wireless communication devices further into our everyday lives. For example, modern cellular radiotelephones function as traditional voice communication devices, but also offer a diverse range of additional features. Such features include portable digital assistant features (so called “smart phones”), music management features, including retrieval, storage, and playback, as well as robust data service features, including web browsing, emailing, and text messaging.

Improved user interfaces, increased battery capacities, and the improved access to a diverse range of data networks, all contribute to the expanding role and flexibility of wireless communication devices. With this increased flexibility come new opportunities to incorporate additional, non-traditional functions into wireless communication devices. In particular, significant synergies may be realized through the incorporation of non-traditional functions that, for example, capitalize on the robust user interfaces of contemporary wireless communication devices, or that complement the data transmission capabilities of such devices.

### SUMMARY OF THE INVENTION

In one embodiment of the apparatus and methods taught herein, a wireless communication device comprises a range finder configured to generate distance measurement signals by emitting ranging signals and detecting corresponding reflection signals, and one or more processing circuits configured to process the distance measurement signals and output corresponding distance measurement information via the wireless communication device. By way of non-limiting example, the wireless communication device may comprise a cellular radiotelephone, a pager, a laptop or palmtop computer, or other type of mobile communication terminal.

In at least one embodiment, as part of its processing operations, the wireless communication device is configured to output audible signals as a function of the distance measurement information from the range finder. For example, the wireless communication device may output tones or pulses that are modulated as a function of the distance measurements. Similarly, the wireless communication device may be configured to output a vibratory signal, where the amplitude and/or frequency of vibration are determined as a function of the distance measurement information. In either case, the output may be used to provide object proximity information to a vision-impaired person, for example.

In these, and in other embodiments, the wireless communication device may be configured to output distance measurement information to a display screen of the wireless communication device as part of its processing. In this manner, the wireless communication device provides its user with displayed distance readings that may be, for example, controlled or accessed through a software menu of the device. Alternatively or additionally, the wireless communication device may be configured to transmit distance information obtained from the range finder via a communication circuit included in the wireless communication device.

Regardless of such details, the wireless communication device advantageously may include a camera, and the range finder may be aligned with the camera. For example, in at least one such embodiment, the camera includes a lens disposed in or on a housing of the wireless communication device, and the range finder includes a distance sensor disposed in or on the housing in alignment with that lens. Further, in at least one embodiment, the camera lens and the distance sensor are co-located in a protective recess of the device's housing. Optionally, manually or electronically opening the protective cover of the recess enables the camera and the range finder.

By aligning the range finder with the camera, the wireless communication device may be configured to process distance measurement information from the range finder in conjunction with processing digital image data from the camera. For example, the wireless communication device may store distance measurement information from the range finder with related digital image data from the camera in a memory of the wireless communication device. Additionally or alternatively, the wireless communication device may be configured to transmit digital image data and associated distance measurement information to a supporting wireless communication network using the device's cellular communication interface.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a partial block diagram of a wireless communication device that includes a range finder configured to provide distance measurement information for local objects.

FIG. 2 is a more detailed block diagram for one embodiment of the wireless communication device of FIG. 1.

FIG. 3 is a perspective view of a flip configuration for the wireless communication device of FIG. 1.

FIG. 4 is a side view of the wireless communication device of FIG. 3 in an open position.

FIG. 5 is a perspective view of a non-flip configuration of the wireless communication device of FIG. 1.

FIG. 6 is a logic flow diagram, illustrating one embodiment of distance measurement processing that may be carried out by the wireless communication device of FIG. 1.

FIG. 7 is a perspective view of the wireless communication device of FIG. 1, wherein the range finder is configured as a detachable unit.

FIG. 8 is another perspective view of the mobile terminal configuration shown in FIG. 6.

FIG. 9 is a logic flow diagram, illustrating another embodiment of distance measurement processing that may be carried out by the wireless communication device of FIG. 1.

### DETAILED DESCRIPTION

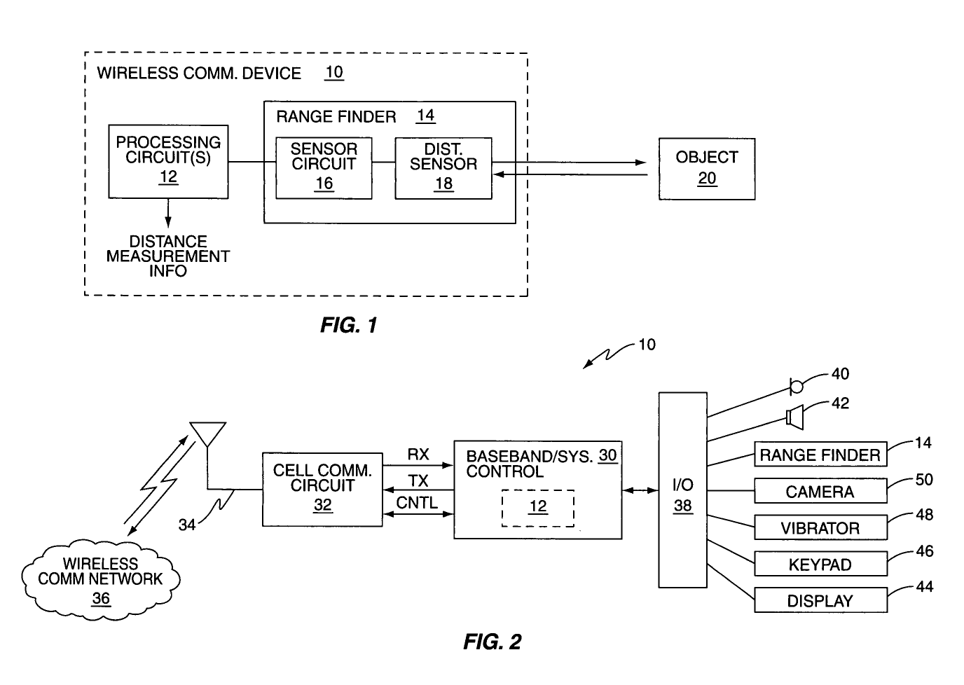

FIG. 1 is a partial block diagram of a wireless communication device 10 that comprises one or more processing circuits 12, and a range finder 14, which may include a sensor circuit 16 and a distance sensor 18. The distance sensor 18 may comprise an infrared or laser-based emitter/sensor pair, or an ultrasonic transducer, or other type of distance-measuring sensor, and the sensor circuit 16 may be configured to provide the appropriate control and bias signals, as needed.

Regardless of its implementation details, the range finder 14 is configured to generate distance measurement signals by emitting ranging signals and detecting corresponding reflection signals returned from a nearby (local) object 20. Complementing this configuration, the one or more processing circuits 12 are configured to process the distance measurement signals and output corresponding distance measurement information via the wireless communication device 10.

As used herein, the term “wireless communication device” should be construed broadly. By way of non-limiting example, the wireless communication device 10 illustrated in FIG. 1 may comprise a mobile radiotelephone, such as a cellular handset or other mobile terminal, a wireless pager, a wireless portable digital assistant (PDA), a laptop or palmtop computer, or other type of portable communication device. Regardless, the incorporation of the range finder 14 into the wireless communication device 10 offers many advantages, some of which are introduced in the context of FIG. 2.

FIG. 2 is a block diagram illustrating additional details for one embodiment of the wireless communication device 10, wherein the wireless communication device 10 comprises baseband/system control circuits 30, a cellular communication circuit 32 and an associated receive/transmit antenna 34, input/output (I/O) interface circuits 38, and various user interface elements including a microphone 40, a speaker 42, a display screen 44, a keypad 46, a vibrator 48, and a camera 50. Of course, it should be understood that one or more of the illustrated user interface elements may be omitted from the wireless communication device 10, as needed or desired.

In operation, the wireless communication device 10 is configured to wirelessly communicate with a supporting wireless communication network 36, and, in some embodiments, it may be configured to transmit distance measurement information to the wireless communication network 36 (or to systems accessible through the network 36). To that end, the processing circuit(s) 12 may be associated with or included in the baseband/system control circuits 30, such that distance measurement information is formatted for transmission via the cellular communication circuit 32.

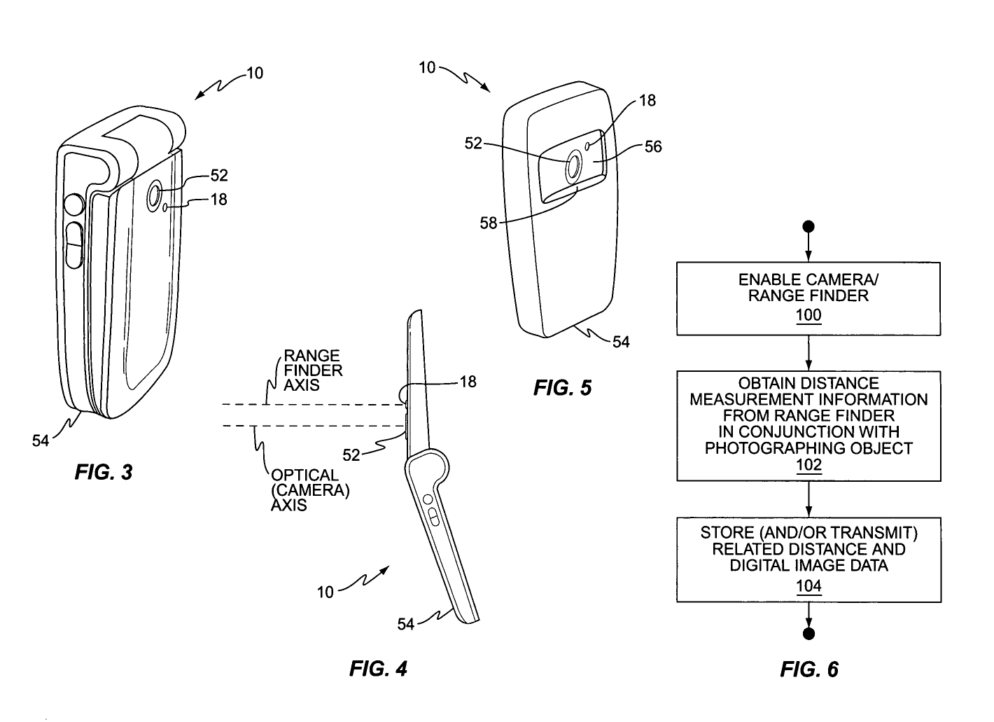

However, independent of whether distance measurement information is transmitted from the wireless communication device 10, incorporation of the range finder 14 offers a number of synergistic functions that complement basic operation of the wireless communication terminal 10. For example, FIGS. 3 and 4 illustrate a flip-phone configuration of the wireless communication device 10, wherein a camera lens 52 and the distance sensor 18 are disposed in or on an enclosure 54 of the wireless communication device 10.

In particular, FIG. 4 illustrates an advantageous configuration, wherein the range finder 14 is aligned with the camera 50, such that a user of the camera 50 can obtain distance measurements relative to objects imaged (still or video) by the camera 50. Such alignment may be achieved by aligning the range-finding axis of the distance sensor 18 with the optical axis of the camera lens 52. It should be noted that the wireless communication device 10 can include software that allows its users to conveniently access and control such range finding operations in conjunction with controlling camera functions.

FIG. 5 illustrates an alternative configuration for the wireless communication device 10, wherein the enclosure 54 is configured as a non-flip housing. Of more interest, however, the enclosure 54 includes a protected recess 56 in which the camera lens 52 and the distance sensor 18 are co-located. A moving cover 58 (e.g., a shutter) may protect the recess 56. Advantageously, the wireless communication device 10 can be configured to enable the range finder 14 and/or the camera 50 in response to the cover 58 being opened.

As an example of the synergy gained by including the range finder 14 in camera-enabled embodiments of the wireless communication device 10, FIG. 6 illustrates processing logic wherein range finding functions complement the camera's imaging functions. Processing begins with the wireless communication device enabling the camera 50 and the range finder 14 (Step 100). Processing continues with the wireless communication device 10 obtaining distance measurement information from the range finder 14 in conjunction with imaging an object via the camera 50 (Step 102). The wireless communication device 10 then stores and/or transmits the related distance and digital image data (Step 104).

Thus, the wireless communication device 10 may store distance measurement information obtained from the range finder 14 in conjunction with related digital image data obtained from the camera 50 in a memory of the wireless communication device 10. Such memory may be included in or associated with the one or more processing circuits 12, or the baseband/system control circuits 30.

Additionally, or alternatively, the wireless communication device 10 may transmit related distance measurement information and digital image data to the wireless communication network 36, or to a system accessible through the wireless communication network 36. For example, the wireless communication device 10 may include a software application that is configured to obtain digital image data and related distance measurement information and send the collected data to information control circuits 30. The bundling of distance information and related digital image data can facilitate a number of applications that may run on, or be supported by, the wireless communication device 10, such as accident investigation, surveying, site and building inspections, etc.

In at least some embodiments, the camera 50 provides the wireless communication device 10 with video recording capability, and this capability is enhanced with the device's range-finding ability. For example, the wireless communication device 10 may provide “live” video images on its display screen 42, based on digital image data provided by the camera 50. In this context, the wireless communication device 10 may overlay distance information onto the video images. That is, the wireless communication device 10 may display distance information related to distance measurements made by the range finder 14 for one or more objects within the camera's current field of view.

The distance information may be “live” in that it dynamically updates as the user pans the camera 50, or as objects move within the camera's field of view. At least one embodiment of the wireless communication device 10 is configured to provide live distance measurements, and to enhance that capability by tying other device features to its live distance measurements. For example, the wireless communication device may include stopwatch and/or other timing functions that are started and stopped responsive to the live distance measurements.

In more detail, the wireless communication device 10 can be configured to allow the user to program a timer stop distance and to trigger the timer start responsive to movement detection (i.e., a detection in changed object distance). With this configuration, the user can point the camera 50 at a given object (a runner, for example), and the device's timer starts responsive to the object beginning to move away from the wireless communication device 10, and stops responsive to the object reaching the programmed timer stop distance.

Of course, those skilled in the art will immediately recognize the above example as just one of many possibilities, and will further realize that such functionality can be implemented to a satisfactory level even if the camera 50 does not support full motion video. For example, the “live” distance measurements may be provided based on the camera 50 taking successive images at reasonably short intervals.

Thus, it should be understood that the ability to support dynamically changing distance information on the display 42 of the wireless communication device 10 does not require that either the camera 50 or wireless communication device 10 be configured to support video, although video capability may be preferable. In general, objects are “imaged” by the camera 50, whether such imaging entails recording a single still image, recording a succession of such images, or recording video. In all such cases, the wireless communication device 10 can be configured to display distance information related to imaged objects and/or to trigger other device functions based on such image information.

Broadly, then, where the range finder 14 is aligned with the camera 50 of the wireless communication device 10, the device's processing circuit(s) 12 may be configured to maintain dynamically updated distance information related to changing object distances within the camera's field of view. More particularly, the wireless communication device 10 may be configured to display the dynamically updated distance information in conjunction with displaying image data from the camera 50 on the display screen 44 and/or to transmit dynamically changing distance measurement information for remote use or recording.

A variety of other types of software applications may be enhanced by inclusion of range finding capabilities, with or without the camera 50. For example, the processing circuit(s) 12 may be configured to maintain dynamically updated distance measurement information, and to control a function of the wireless communication device 10 responsive to the dynamically updated distance measurement information. The function(s) may include an elapsed timer function where a timer is started/stopped responsive to changes in measured distance, an audible alarm function where changes in measured distance trigger an alarm, a communication function where changes in measured distance trigger an outgoing communication transmission (to a desired number, for example), and a display update function where changes in measured distance are displayed on the display screen 44.

In other examples, gaming applications may be enhanced through range finding. In particular, range finding may enhance the types of collaborative, online gaming supported through data networks that may be accessible from the wireless communication device 10. Non-limiting examples include team-based play where relative player locations may be important, and scavenger hunt or “orienteering” games, where directions may be given in terms of distances to/from various landmarks, etc.

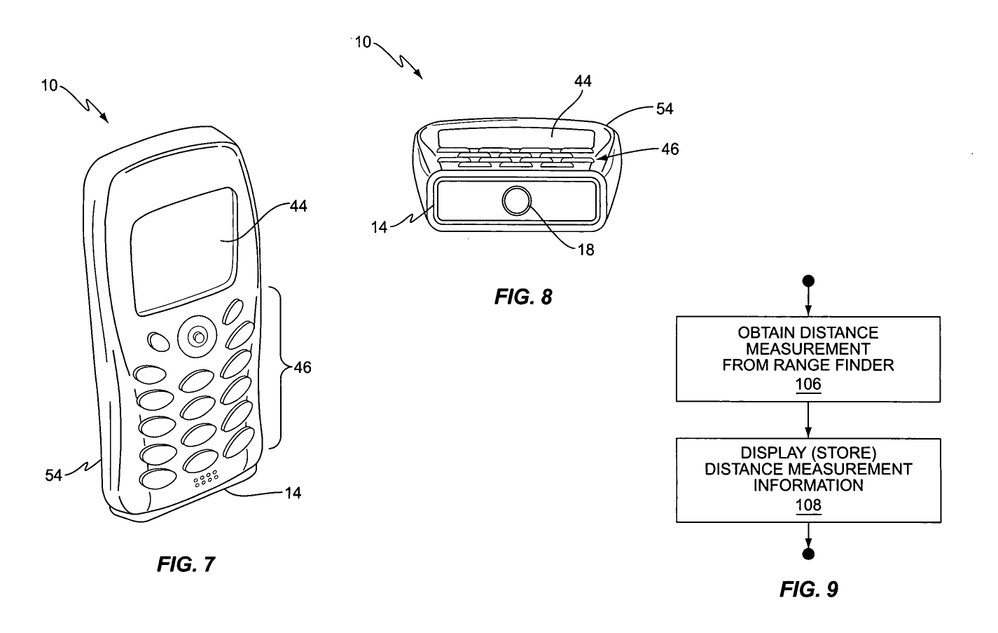

Significantly, range finding enhancements, whether for gaming, surveying, or other purposes, may be added to existing devices. For example, FIG. 7 illustrates yet another embodiment of the wireless communication device 10, wherein the range finder 14 is configured as a detachable module that removably connects to the enclosure 54. Alternatively, the range finder 14 may detachably connect to the enclosure 54 at other locations, such as at the top of the enclosure 54 relative to a display screen 60. Note that the wireless communication device 10 may be configured to re-orient the display information in a direction that complements reading distance information while pointing the range finder 14.

Thus, for the configuration shown in FIG. 8, wherein the range finder 14 points outward from the bottom of the enclosure 54, the wireless communication device 10 may be configured to invert the distance measurement information on the display 60, such that a user can point the distance sensor away from his or her body, and still read distance measurement information on the display screen 60.

Regardless of whether the range finder 14 is configured as an integral or detachable element, the processing logic of FIG. 9 depicts a top-level processing configuration for the one or more processing circuits 12. Processing begins with the processing circuit(s) 12 obtaining a distance measurement from the range finder 14 (Step 100). For example, the processing circuit(s) 12 might send a trigger or initiation signal to the range finder 14 and receive a time-of-flight measurement in return, or might receive start/stop timing signals in return. In that latter case, the processing circuit(s) 12 process the start/top timing information to calculate distance, and they also might be configured to provide unit conversion functions (ft., m, etc.), as needed or desired. Such triggering and processing may be performed on an ongoing basis.

Processing continues with the processing circuits 12 causing distance measurement information to be displayed by the wireless communication device 10, and/or stored within a memory of the wireless communication device 10 (Step 102). The supporting software included in the wireless communication device 10 may be simple or complex. For example, the wireless communication device 10 may be configured simply to display individual distance measurements, or may be configured to display related sets of distance measurements. As one example of the latter case, the wireless communication device 10 may be configured to display a collection of related distance measurements defining a room, or defining the relative location of a particular group of objects.

As such, those skilled in the art will appreciate that the rich user interface functions commonly found in wireless communication devices, such as cellular handsets, enables relatively sophisticated distance measurement functionality. For example, a “handyman's” application may comprise software that programs the wireless communication device 10 to act as a robust digital tape measure, storing and recalling related sets of distances measurements for particular rooms, etc. Further enhancements can exploit the graphical capabilities of the wireless communication device's display screen 44, such as by graphing perimeters or boundaries corresponding to collected distance measurements.

Of course, those skilled in the art will recognize additional features and advantages, and the present invention is not limited by the foregoing discussion, nor by the accompany figures. Indeed, the present invention is limited only by the following claims, and their legal equivalents.

What is claimed is:

1. A wireless communication device comprising:
a range finder configured to generate distance measurement signals by emitting ranging signals and detecting corresponding reflection signals; and
one or more processing circuits configured to process the distance measurement signals and output corresponding distance measurement information via the wireless communication device.

2. The wireless communication device of claim 1, wherein the wireless communication device further comprises a camera, and wherein the range finder is aligned with the camera, such that a user of the camera can obtain distance measurements relative to objects imaged by the camera.

3. The wireless communication device of claim 2, wherein the camera includes a lens disposed in or on a housing of the wireless communication device and the range finder includes a distance sensor disposed in or on the housing in alignment with the lens.

4. The wireless communication device of claim 2, wherein the camera lens and the distance sensor are co-located in a protected recess of the housing.

5. The wireless communication device of claim 1, wherein the one or more processing circuits are further configured to process distance measurement information from the range finder in conjunction with digital image data from a camera of the wireless communication device.

6. The wireless communication device of claim 5, wherein the one or more processing circuits are configured to process distance measurement information from the range finder in conjunction with digital image data from the camera of the wireless communication device by storing distance measurement information from the range finder with related digital image data from the camera in a memory of the wireless communication device.

7. The wireless communication device of claim 5, wherein the one or more processing circuits further are configured to transmit the distance measurement information with the related digital image data to a supporting wireless communication network.

8. The wireless communication device of claim 1, wherein the one or more processing circuits are configured to output the corresponding distance measurement information via the wireless communication device by transmitting distance measurement information to a supporting wireless communication network.

9. The wireless communication device of claim 1, wherein the wireless communication device includes a user interface, and wherein the one or more processing circuits are configured to output the corresponding distance measurement information via the wireless communication device by outputting the distance measurement information via the user interface.

10. The wireless communication device of claim 9, wherein the user interface includes a display screen, and wherein the one or more processing circuits are configured to cause the distance measurement information to be output on the display screen.

11. The wireless communication device of claim 9, wherein the user interface includes an audio output device, and wherein the one or more processing circuits are configured to cause the distance measurement information to be output via the audio output device.

12. The wireless communication device of claim 1, wherein the one or more processing circuits are configured to output the distance measurement information as auditory tones or pulses from the wireless communication device that are modulated as a function of measured distances.

13. The wireless communication device of claim 1, wherein the one or more processing circuits are configured to output the distance measurement information as vibratory pulses from the wireless communication device that are modulated as a function of measured distances.

14. The wireless communication device of claim 1, wherein the range finder comprises a detachable module associated with the wireless communication device.

15. The wireless communication device of claim 1, wherein the range finder is aligned with a camera of the wireless communication device, and wherein the one or more processing circuits are configured to maintain dynamically updated distance information related to changing object distances within the camera's field of view.

16. The wireless communication device of claim 15, wherein the one or more processing circuits are configured to display the dynamically updated distance information in conjunction with image data from the camera on a display screen of the wireless communication device.

17. The wireless communication device of claim 1, wherein the one or more processing circuits are configured to maintain dynamically updated distance measurement information, and to control a function of the wireless communication device responsive to the dynamically updated distance measurement information.

18. The wireless communication device of claim 17, wherein the function is at least one of an elapsed timer function, an audible alarm function, a communication function, and a display update function, wherein distance measurement information displayed on a display screen of the wireless communication device is updated.

19. A method of incorporating distance measurement functions into a wireless communication device comprising:
including a range finder within the wireless communication device; and
configuring the wireless communication device to process distance measurement information determined from the range finder.

20. The method of claim 19, wherein configuring the wireless communication device to process distance measurement information determined from the range finder comprises configuring the wireless communication device to output audible signals as a function of the distance measurement information.

21. The method of claim 20, wherein configuring the wireless communication device to output audible signals as a function of the distance measurement information comprises configuring the wireless communication device to output audible tones or pulses that are modulated as a function of the distance measurement information.

22. The method of claim 20, wherein configuring the wireless communication device to output audible signals as a function of the distance measurement information comprises configuring the wireless communication device to output synthesized speech corresponding to the distance measurement information.

23. The method of claim 20, wherein configuring the wireless communication device to process distance measurement information determined from the range finder comprises configuring the wireless communication device to output vibratory pulses as a function of the distance measurement information.

24. The method of claim 19, wherein configuring the wireless communication device to process distance measurement information determined from the range finder comprises configuring the wireless communication device to display the distance measurement information on a display screen of the wireless communication device.

25. The method of claim 19, wherein configuring the wireless communication device to process distance measurement information determined from the range finder comprises configuring the wireless communication device to transmit the distance measurement information via a communication circuit included in the wireless communication device.

26. The method of claim 19, further comprising aligning the range finder with a camera included in the wireless communication device, and configuring the wireless communication device to obtain distance measurements for objects imaged by the camera.

27. The method of claim 26, wherein configuring the wireless communication device to process distance measurement information determined from the range finder comprises configuring the wireless communication device to process distance measurement information from the range finder in conjunction with digital image data from the camera.

28. The method of claim 27, wherein configuring the wireless communication device to process distance measurement information from the range finder in conjunction with digital image data from the camera comprises configuring the wireless communication device to store distance measurement information from the range finder with related digital image data from the camera in a memory of the wireless communication device.

29. The method of claim 27, wherein configuring the wireless communication device to process distance measurement information from the range finder in conjunction with digital image data from the camera comprises configuring the wireless communication device to transmit the distance measurement information with the related digital image data to a supporting wireless communication network.

30. The method of claim 19, wherein the range finder is aligned with a camera of the wireless communication device, and wherein configuring the wireless communication device to process distance measurement information determined from the range finder comprises configuring the wireless communication device to maintain dynamically updated distance information related to changing object distances within the camera's field of view.

31. The method of claim 30, wherein configuring the wireless communication device to maintain dynamically updated distance information related to changing object distances within the camera's field of view comprises configuring the wireless communication device to display the dynamically updated distance information in conjunction with image data from the camera on a display screen of the wireless communication device.

32. The method of claim 19, wherein configuring the wireless communication device to process distance measurement information determined from the range finder comprises configuring the wireless communication device to maintain dynamically updated distance measurement information, and to control a function of the wireless communication device responsive to the dynamically updated distance measurement information.

33. The method of claim 32, wherein configuring the wireless communication device to control a function of the wireless communication device responsive to the dynamically updated distance measurement information comprises configuring the wireless communication device to control at least one of an elapsed timer function, an audible alarm function, a communication function, and a display update function, wherein distance measurement information displayed on a display screen of the wireless communication device is updated.
